(19) United States
(12) Patent Application Publication
(10) Pub. No.: US 2019/0311842 A1
(43) Pub. Date: Oct. 10, 2019

(54) COIL COMPONENT

(71) Applicant: Murata Manufacturing Co., Ltd., Kyoto-fu (JP)

(72) Inventors: Katsuhisa IMADA, Nagaokakyo-shi (JP); Keiichi YOSHINAKA, Nagaokakyo-shi (JP); Keishiro AMAYA, Nagaokakyo-shi (JP); Hiroyuki KANBARA, Nagaokakyo-shi (JP)

(73) Assignee: Murata Manufacturing Co., Ltd., Kyoto-fu (JP)

(21) Appl. No.: 16/373,548

(22) Filed: Apr. 2, 2019

(30) Foreign Application Priority Data
Apr. 9, 2018 (JP) 2018-075074
Dec. 21, 2018 (JP) 2018-240084

(51) Int. Cl. H01F 27/29; H01F 41/10; H01F 27/32

(52) U.S. Cl. CPC H01F 27/292; H01F 27/327; H01F 41/10

(57) ABSTRACT

A coil component including an element assembly that contains a filler and a resin material, a coil portion composed of a coil conductor that is embedded in the element assembly, and a pair of outer electrodes electrically connected to the coil conductor. Also, the coil conductor is covered with a glass layer.

### CROSS-REFERENCE TO RELATED APPLICATIONS

This application claims benefit of priority to Japanese Patent Application No. 2018-075074, filed Apr. 9, 2018, and to Japanese Patent Application No. 2018-240084, filed Dec. 21, 2018, the entire content of each is incorporated herein by reference.

### BACKGROUND

### Technical Field

The present disclosure relates to a coil component.

### Background Art

Regarding a coil component in which a coil conductor is embedded in an element assembly portion, a coil component in which an α-winding coil is embedded in an element assembly composed of a composite material containing metal particles and a resin material is known, as described in Japanese Unexamined Patent Application Publication No. 2016-201466.

The coil component that includes the composite material containing the resin material is produced by preparing a composite material sheet containing the resin material, placing a coil thereon, further placing another composite material sheet from above the coil, and performing compression molding. In the case in which the coil component is produced by interposing the cc-winding coil that is formed separately between composite material sheets, size reduction of the coil is difficult, and compression molding is difficult because the strength of the coil portion is reduced as size reduction advances.

### SUMMARY

Accordingly, the present disclosure provides a coil component in which a coil portion is embedded in an element assembly containing a resin material and which has advantages in size reduction.

According to preferred embodiments of the present disclosure, the following aspects are included.

(1) A coil component including an element assembly that contains a filler and a resin material, a coil portion composed of a coil conductor that is embedded in the element assembly, and a pair of outer electrodes electrically connected to the coil conductor, wherein the coil conductor is covered with a glass layer.

(2) The coil component according to (1) described above, wherein the thickness of the glass layer is about 3 μm or more and 30 μm or less (i.e., from about 3 μm to 30 μm).

(3) The coil component according to (1) or (2) described above, wherein the thickness of the coil conductor is about 3 μm or more and 200 μm or less (i.e., from about 3 μm to 200 μm).

(4) The coil component according to any one of (1) to (3) described above, wherein the outer electrodes are disposed on the lower surface of the element assembly.

(5) The coil component according to any one of (1) to (4) described above, wherein the filler is metal particles, ferrite particles, or glass particles.

(6) The coil component according to (5) described above, wherein the filler is metal particles.

(7) The coil component according to any one of (1) to (6) described above, wherein the axis direction of the coil portion is substantially parallel to the lower surface of the element assembly.

(8) The coil component according to any one of (1) to (7) described above, wherein the coil conductor is fired, and the element assembly is unfired.

(9) A method for manufacturing a coil component including an element assembly that contains a filler and a resin material, a coil portion composed of a coil conductor that is embedded in the element assembly, and a pair of outer electrodes electrically connected to the coil conductor, with the coil conductor being covered with a glass layer. The method includes the steps of forming, on a substrate, a conductor paste layer of a photosensitive metal paste containing a metal that constitutes the coil conductor by using a photolithography method, forming a glass paste layer of a photosensitive glass paste containing glass that constitutes the glass layer by using the photolithography method so as to cover the conductor paste layer, forming a retaining layer of a photosensitive paste that can be removed after firing in regions, in which neither the conductor paste layer nor the glass paste layer is present, on the substrate, and forming a coil portion on the substrate by firing the substrate provided with the conductor paste layer, the glass paste layer, and the retaining layer.

(10) The method for manufacturing a coil component according to (9) described above, further including the steps of pressing an element assembly sheet containing an element assembly material into the coil portion disposed on the substrate, removing the substrate, and providing the portion, from which the substrate has been removed, with an element assembly sheet.

Other features, elements, characteristics and advantages of the present disclosure will become more apparent from the following detailed description of preferred embodiments of the present disclosure with reference to the attached drawings.

### BRIEF DESCRIPTION OF THE DRAWINGS

FIG. 1 is a perspective view of a coil component according to a first embodiment of the present disclosure;

FIG. 2 is a sectional view of the section of the coil component along line X-X in FIG. 1;

FIG. 3 is a perspective view of a coil portion of the coil component in FIG. 1;

FIGS. 4A to 4F are diagrams illustrating the method for manufacturing the coil component in the first embodiment;

FIGS. 5A to 5D are diagrams illustrating the method for manufacturing the coil component in the first embodiment;

FIGS. 6A to 6C are diagrams illustrating the method for manufacturing the coil component in the first embodiment;

FIGS. 7A to 7D are diagrams illustrating the method for manufacturing a coil component in a modification of the first embodiment;

FIG. 8 is a sectional view of the section of the coil component in the modification of the first embodiment;

FIG. 9 is a perspective view of a coil portion of the coil component in the modification of the first embodiment;

FIG. 10 is a perspective view of a coil component according to a second embodiment of the present disclosure;

FIG. 11 is a sectional view of the section of the coil component along line X-X in FIG. 10;

FIG. 12 is a perspective view of a coil portion of the coil component in FIG. 10;

FIGS. 13A to 13F are diagrams illustrating the method for manufacturing the coil component in the second embodiment;

FIGS. 14A to 14D are diagrams illustrating the method for manufacturing the coil component in the second embodiment;

FIG. 15 is a perspective view of a coil component according to a third embodiment of the present disclosure;

FIG. 16 is a sectional view of the section of the coil component along line X-X in FIG. 15;

FIG. 17 is a perspective view of a coil portion of the coil component in FIG. 15;

FIGS. 18A to 18F are diagrams illustrating the method for manufacturing the coil component in the third embodiment; and

FIGS. 19A to 19H are diagrams illustrating the method for manufacturing the coil component in the third embodiment.

### DETAILED DESCRIPTION

The coil component according to preferred embodiments of the present disclosure will be described below with reference to the drawings. In this regard, the shapes, arrangements, and the like of the coil component and constituent elements of the present embodiment are not limited to the examples illustrated.

### First Embodiment

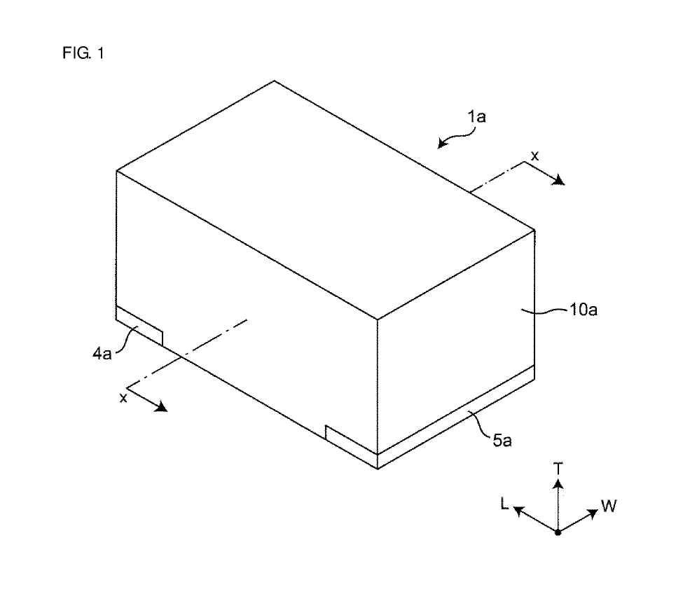

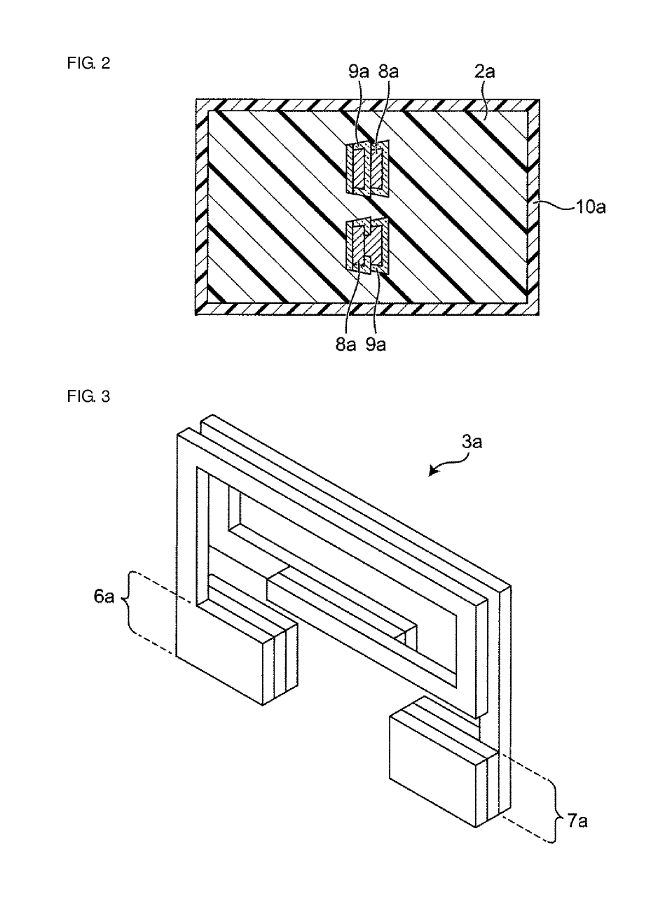

FIG. 1 is a perspective view of the coil component 1a according to the present embodiment, and FIG. 2 is a schematic sectional view thereof. FIG. 3 is a schematic perspective view of a coil portion 3a of the coil component 1a. In this regard, the shapes, arrangements, and the like of the coil component and constituent elements of the embodiment described below are not limited to the examples illustrated.

As shown in FIG. 1 to FIG. 3, the coil component 1a according to the present embodiment is in the shape of a substantially rectangular parallelepiped. In the coil component 1a, the surfaces in the right and left portions of FIG. 2 are denoted as “end surfaces”, the surface in the upper portion of FIG. 2 is denoted as an “upper surface”, the surface in the lower portion of FIG. 2 is denoted as a “lower surface”, the surface in the near portion of FIG. 2 is denoted as a “front surface”, and the surface in the far portion of FIG. 2 is denoted as a “back surface”. Briefly, the coil component 1a includes an element assembly 2a, the coil portion 3a embedded in the element assembly 2a, and a pair of outer electrodes 4a and 5a. The coil portion 3a has an axis that extends in front-surface and back-surface directions of the element assembly, that is, an axis parallel to a mounting surface. As shown in FIG. 3, the coil portion 3a has extension portions 6a and 7a, which are electrically connected to the outer electrodes 4a and 5a, respectively. As shown in FIG. 2, a coil conductor 8a of the coil portion 3a is covered with a glass layer 9a. Meanwhile, the coil component 1a except the outer electrodes 4a and 5a is covered with an insulating layer 10a.

In the present specification, the length of the coil component 1a is denoted as “L”, the width is denoted as “W”, and the thickness (height) is denoted as “T” (refer to FIG. 1). In the present specification, the surface parallel to the front surface and the back surface is denoted as the “LT surface”, the surface parallel to the end surface is denoted as the “WT surface”, and the surface parallel to the upper surface and the lower surface is denoted as the “LW surface”.

The element assembly 2a is composed of a composite material containing a filler and a resin material. There is no particular limitation regarding the resin material. Examples of the resin material include thermosetting resins, for example, an epoxy resin, a phenol resin, a polyester resin, a polyimide resin, and a polyolefin resin. One type of the resin material may be used alone, or at least two types may be used.

The filler is preferably metal particles, ferrite particles, or glass particles and more preferably metal particles. One type of the filler may be used alone, or a plurality of types may be used in combination.

According to an aspect, the filler has an average particle diameter of preferably about 0.5 μm or more and 50 μm or less (i.e., from about 0.5 μm to 50 μm), more preferably about 0.5 μm or more and 30 μm or less (i.e., from about 0.5 μm to 30 μm), and further preferably about 0.5 μm or more and 10 μm or less (i.e., from about 0.5 μm to 10 μm). Setting the average particle diameter of the filler to be about 0.5 μm or more enables the filler to be readily handled. Meanwhile, setting the average particle diameter of the filler to be about 50 μm or less enables the filling ratio of the filler to be increased and enables the characteristics of the filler to be more effectively obtained. For example, in the case in which the filler is metal particles, the magnetic characteristics are improved.

The average particle diameter is calculated from the equivalent circle diameter of the filler in a scanning electron microscope (SEM) image of the cross section of the element assembly. For example, the average particle diameter can be obtained by taking SEM photographs of a plurality of (for example, five) regions (for example, 130 μm×100 μm) in a cross section obtained by cutting the coil component 1a, analyzing the resulting SEM images by using image analysis software (for example, Azokun (registered trademark) produced by Asahi Kasei Engineering Corporation) so as to determine the equivalent circle diameter of 500 or more of metal particles, and calculating the average thereof.

There is no particular limitation regarding the metal material that constitutes the metal particles. Examples of the metal material include iron, cobalt, nickel, and gadolinium and an alloy of at least one of these. Preferably, the metal material is iron or an iron alloy. Iron may be iron only or an iron derivative, for example, a complex. There is no particular limitation regarding such an iron derivative, and examples of the iron derivative include iron carbonyl, which is a complex of iron and CO, preferably iron pentacarbonyl. In particular, a hard-grade iron carbonyl (for example, a hard-grade iron carbonyl produced by BASF) having an onion skin structure (structure in which concentric-sphere-shaped layers are formed around the center of a particle) is preferable. There is no particular limitation regarding the iron alloy, and examples of the iron alloy include Fe—Si-based alloys, Fe—Si—Cr-based alloys, Fe—Si—Al-based alloys, Ne—Ni-based alloys, Fe—Co-based alloys, and Fe—Si—B—Nb—Cu-based alloys. The above-described alloys may further contain B, C, and the like as other secondary components. There is no particular limitation regarding the content of the secondary component, and the content may be, for example, about 0.1% by weight or more and 5.0% by weight or less (i.e., from about 0.1% by weight to 5.0% by weight) and preferably about 0.5% by weight or more and 3.0% by weight or less (i.e., from about 0.5% by weight to 3.0% by weight). One type of the metal material may be used alone, or at least two types may be used.

The surfaces of the metal particles may be covered with a coating of an insulating material (hereafter also referred to simply as an “insulating coating”). The specific resistance of the inside of the element assembly can be increased by covering the surfaces of the metal particles with the insulating coating.

The surface of each metal particle may be covered with the insulating coating to the extent that the insulation performance between the particles can be enhanced, and part of the surface of each metal particle may be covered with the insulating coating. There is no particular limitation regarding the form of the insulating coating, and the form of a network or a layer may be adopted. In a preferred aspect, regarding each of the metal particles, the region corresponding to about 30% or more, preferably about 60% or more, more preferably about 80% or more, further preferably about 90% or more, and particularly preferably 100% of the surface may be covered with the insulating coating.

There is no particular limitation regarding the thickness of the insulating coating. The thickness is preferably about 1 nm or more and 100 nm or less (i.e., from about 1 nm to 100 nm), more preferably about 3 nm or more and 50 nm or less (i.e., from about 3 nm to 50 nm), and further preferably about 5 nm or more and 30 nm or less (i.e., from about 5 nm to 30 nm), and may be, for example, about 10 nm or more and 30 nm or less (i.e., from about 10 nm to 30 nm) or about 5 nm or more and 20 nm or less (i.e., from about 5 nm to 20 nm). The specific resistance of the element assembly can be increased by increasing the thickness of the insulating coating. In addition, decreasing the thickness of the insulating coating enables the amount of the metal material in the element assembly to be increased, which improves the magnetic characteristics of the element assembly, readily realizing a size reduction of the coil component.

According to an aspect, the insulating coating is formed of an insulating material containing Si. Examples of the insulating material containing Si include silicon-based compounds, for example, SiOₓ (x is about 1.5 or more and 2.5 or less (i.e., from about 1.5 to 2.5), and SiOₓ is typically SiO₂). According to an aspect, the insulating coating is an oxide film formed by oxidizing the surface of the metal particle.

There is no particular limitation regarding the method for applying the insulating coating, and a coating method known to a person skilled in the art, for example, a sol-gel method, a mechanochemical method, a spray drying method, a fluidized-bed granulation method, an atomization method, and a barrel sputtering method, may be used. There is no particular limitation regarding the ferrite material constituting the ferrite particles, and examples include a ferrite material containing Fe, Zn, Cu, and Ni as primary components.

According to an aspect, the ferrite particles may be covered with the insulating coating in the same manner as the metal particles. The specific resistance of the inside of the element assembly can be increased by covering the surfaces of the ferrite particles with the insulating coating. There is no particular limitation regarding the glass material constituting the glass particles, and examples include Bi—B—O-based glass, V—P—O-based glass, Sn—P—O-based glass, and V—Te—O-based glass.

As shown in FIG. 2 and FIG. 3, in the coil component 1a according to the present embodiment, the two ends of the coil portion 3a are set to extend downward in the element assembly 2a by using the extension portions 6a and 7a and are exposed at the lower surface of the element assembly 2a. The axis of the coil portion 3a is parallel to the mounting surface, that is, the axis of the coil portion 3a extends in the direction from the front surface of the element assembly 2a toward the back surface (i.e., W-direction). Setting the axis of the coil portion to be parallel to the mounting surface enables the extension portion that is formed in the lateral direction of a winding portion to be reduced, or there is no need to form an extension portion in the lateral direction of the winding portion. In other words, a region in which the winding portion overlaps the extension portion can be reduced or such a region can be eliminated in plan view. Therefore, stray capacitance generated between the winding portion and the outer electrode can be decreased. In addition, the L-value acquisition efficiency can be increased because the diameter of the winding can be increased. Meanwhile, the number of turns of the coil portion 3a of the coil component 1a is about 1.5. However, there is no particular limitation regarding the number of turns of the coil component according to the present disclosure, and the number of turns may be appropriately selected in accordance with the purpose.

In the coil component 1a, coil conductors 8a constituting the coil portion 3a are stacked in the W-direction. Therefore, the cross section of the coil conductor 8a constituting the coil portion 3a is longer in the T-direction than in the L-direction. Stray capacitance between the coil portion 3a and the outer electrodes 4a and 5a can be decreased by the coil conductor 8a having the above-described form.

There is no particular limitation regarding a conductive material constituting the coil conductor 8a, and examples of the conductive material include gold, silver, copper, palladium, and nickel. The conductive material is preferably silver or copper and more preferably silver. One type of the conductive material may be used alone, or at least two types may be used.

The thickness of the coil conductor 8a (thickness in the lateral direction in FIG. 2) is preferably about 3 μm or more and 200 μm or less (i.e., from about 3 μm to 200 μm), more preferably about 5 μm or more and 100 μm or less (i.e., from about 5 μm to 100 μm), and further preferably about 10 μm or more and 100 μm or less (i.e., from about 10 μm to 100 μm). The resistance of the coil conductor 8a can be reduced by increasing the thickness of the coil conductor. Meanwhile, size reduction of the coil component is facilitated by decreasing the thickness of the coil conductor 8a.

The width of the coil conductor 8a (width in the vertical direction in FIG. 2) is preferably about 5 μm or more and 1 mm or less (i.e., from about 5 μm to 1 mm), more preferably about 10 μm or more and 500 μm or less (i.e., from about 10 μm to 500 μm), further preferably about 15 μm or more and 300 μm or less (i.e., from about 15 μm to 300 μm), and still more preferably 20 μm or more and 100 μm or less (i.e., from about 20 μm to 100 μm). The coil conductor can be reduced in size by decreasing the width of the coil conductor, and there are advantages in size reduction of the coil component. Meanwhile, the resistance of the conducting wire can be reduced by increasing the width of the coil conductor.

The coil portion 3a has extension portions 6a and 7a. The extension portions 6a and 7a extend from the winding portion of the coil portion toward the outer electrodes and are electrically connected to the outer electrodes 4a and 5a, respectively. The width of the extension portions is preferably about 1.0 or more times and 6.0 or less times (i.e., from about 1.0 times to 6.0 times), more preferably more than about 1.0 times and 6.0 or less times (i.e., from more than about 1.0 times to 6.0 times), further preferably about 1.5 or more times and 5.0 or less times (i.e., from about 1.5 times to 5.0 times), and still more preferably 2.0 or more times and 4.0 or less times (i.e., from 2.0 times to 4.0 times) the width of the winding portion. The width of the extension portion is the width of the portion in contact with the outer electrode and is denoted as the width in the L-direction in the present embodiment. When the width of the extension portion is set to be 1.0 or more times the width of the coil conductor, particularly more than the width of the coil conductor, the extension portion is more reliably connected to the outer electrode, and reliability is improved.

In the coil component according to the present disclosure, the coil conductor 8a is covered with a glass layer 9a. There is no particular limitation regarding a glass material constituting the glass layer 9a. Examples of the glass material include SiO₂—B₂O₃-based glass, SiO₂—B₂O₃—K₂O-based glass, SiO₂—B₂O₃—Li₂O—CaO-based glass, SiO₂—B₂O₃—Li₂O—CaO—ZnO-based glass, and Bi₂O₃—B₂O₃—SiO₂—Al₂O₃-based glass. In a preferred aspect, the glass material is SiO₂—B₂O₃—K₂O-based glass. When the SiO₂—B₂O₃—K₂O-based glass is used, the sinterability during formation of the glass layer is enhanced.

According to an aspect, the glass layer 9a may further contain a filler. Examples of the filler contained in the glass layer include quartz, alumina, magnesia, silica, forsterite, steatite, and zirconia.

The thickness of the glass layer 9a is preferably about 3 μm or more and 30 μm or less (i.e., from about 3 μm to 30 μm) and more preferably about 5 μm or more and 20 μm or less (i.e., from about 5 μm to 20 μm). Setting the thickness of the glass layer 9a to be about 3 μm or more enables the coil portion to be more firmly supported and enables the insulating performance between the coil portion and the element assembly to be enhanced. Setting the thickness of the glass layer 9a to be about 30 μm or less enables the coil component to be reduced in size.

The outer electrodes 4a and 5a are disposed on the lower surface of the coil component 1a. The coil component 1a can be surface-mounted by disposing the outer electrodes on the lower surface. In addition, stray capacitance is reduced compared with the case in which the outer electrodes are disposed on the side surfaces.

The outer electrodes 4a and 5a are disposed on the extension portions 6a and 7a, respectively, of the coil portion 3a that extend to the lower surface of the element assembly 2a. That is, the outer electrodes 4a and 5a are electrically connected to the extension portions 6a and 7a, respectively, of the coil portion 3a.

According to an aspect, the outer electrodes 4a and 5a may be not only disposed on the extension portions 6a and 7a, respectively, of the coil portion 3a that extend to the lower surface of the element assembly 2a but may also extend beyond the end portions of the coil conductor to the other portions of the lower surface of the coil component.

According to an aspect, the outer electrodes 4a and 5a are disposed in the region in which the insulating layer 10a is not provided, that is, in the entire region at which the element assembly 2a and the coil portion 3a are exposed. According to an aspect, the outer electrodes 4a and 5a may extend to the end surfaces of the coil component.

There is no particular limitation regarding the thickness of the outer electrode, and the thickness may be, for example, about 1 μm or more and 100 μm or less (i.e., from about 1 μm to 100 μm), preferably about 5 μm or more and 50 μm or less (i.e., from about 5 μm to 50 μm), and more preferably about 5 μm or more and 20 μm or less (i.e., from about 5 μm to 20 μm).

The outer electrode is composed of a conductive material, preferably at least one metal material selected from a group consisting of Au, Ag, Pd, Ni, Sn, and Cu. The outer electrode is formed by plating or by applying a paste containing a conductive material and performing curing or baking. Preferably, the outer electrode is formed by plating. The outer electrode may be a single layer or a multilayer.

According to an aspect, the outer electrode is a multilayer. Preferably, the outer electrode may be composed of three layers consisting of a Cu layer, a Ni layer, and a Sn layer, or two layers consisting of a Ni layer and a Sn layer. The adhesiveness of the plating to the element assembly can be enhanced by forming a Cu layer on the element assembly 2a.

According to another aspect, the outer electrode may be composed of three layers consisting of a Ag layer, a Ni layer, and a Sn layer. The Ag layer may be formed by applying a paste containing a Ag powder and a resin and performing heat-curing or be formed by applying a paste containing a Ag powder and a resin and performing baking. The Ni layer and the Sn layer are sequentially formed thereon by plating.

The coil component 1a except the outer electrodes 4a and 5a is covered with an insulating layer 10a. There is no particular limitation regarding the thickness of the insulating layer 10a, and the thickness is preferably about 3 μm or more and 20 μm or less (i.e., from about 3 μm to 20 μm), more preferably about 3 μm or more and 10 μm or less (i.e., from about 3 μm to 10 μm), and further preferably about 3 μm or more and 8 μm or less (i.e., from about 3 μm to 8 μm). Setting the thickness of the insulating layer to be within the above-described range enables an increase in size of the coil component 1a to be suppressed and, in addition, enables the insulation performance of the surface of the coil component 1a to be ensured.

Examples of the insulating material constituting the insulating layer 10a include resin materials having high electric insulation performance such as an acrylic resin, an epoxy resin, and a polyimide resin. The insulating layer 10a may be formed of at least two types of resin materials. A two-layer structure consisting of an acrylic resin and an epoxy resin is more preferable because impact resistance is improved. In the coil component according to the present disclosure, the insulating layer 10a is not indispensable and may be omitted.

The coil component according to the present disclosure can be reduced in size while having excellent electric characteristics. According to an aspect, the length (L) of the coil component according to the present disclosure is preferably about 0.38 mm or more and 1.75 mm or less (i.e., from about 0.38 mm to 1.75 mm) and more preferably about 0.38 mm or more and 1.05 mm or less (i.e., from about 0.38 mm to 1.05 mm). According to an aspect, the width (W) of the coil component according to the present disclosure is preferably about 0.18 mm or more and 0.95 mm or less (i.e., from about 0.18 mm to 0.95 mm) and more preferably about 0.18 mm or more and 0.55 mm or less (i.e., from about 0.18 mm to 0.55 mm). According to a preferred aspect, regarding the coil component according to the present disclosure, the length (L) may be about 1.0 mm and the width (W) may be about 0.5 mm. Preferably, the length (L) may be about 0.6 mm and the width (W) may be about 0.3 mm. More preferably, the length (L) may be about 0.4 mm and the width (W) may be about 0.2 mm. According to an aspect, the height (or thickness (T)) of the coil component according to the present disclosure is preferably about 0.95 mm or less and more preferably about 0.55 mm or less.

Next, a method for manufacturing the coil component 1a will be described.

Production of Magnetic Sheet (Element Assembly Sheet)

Metal particles (filler) and a resin material are prepared. The metal particles and other filler components (a glass powder, a ceramic powder, a ferrite powder, and the like), as the situation demands, are wet-mixed with the resin material so as to form a slurry, a sheet having a predetermined thickness is formed by using a doctor blade method or the like, and drying is performed. In this manner, a magnetic sheet of a composite material of the metal particles and the resin material is produced.

Photosensitive Conductor Paste

Conductive particles, for example, a Ag powder is prepared. A predetermined amount of the conductive particles are mixed with a varnish prepared by mixing a solvent and an organic component so as to produce a photosensitive conductor paste.

Photosensitive Glass Paste

A glass powder is prepared. A predetermined amount of the glass powder is mixed with a varnish prepared by mixing a solvent and an organic component so as to produce a photosensitive glass paste.

Shape-Retaining Photosensitive Paste

A material that disappears at a firing stage and, as the situation demands, an inorganic material powder that does not sinter at a firing stage are prepared. Examples of the material that disappears at a firing stage include an organic material, preferably the above-described varnish. Examples of the above-described inorganic material include a ceramic powder, for example, alumina. The D50 of the inorganic material is preferably about 0.1 μm or more and 10 μm or less (i.e., from about 0.1 μm to 10 μm). A predetermined amount of the inorganic material powder that does not sinter at a firing stage is mixed with a varnish prepared by mixing a solvent and an organic component so as to produce a shape-retaining photosensitive paste.

Production of Element

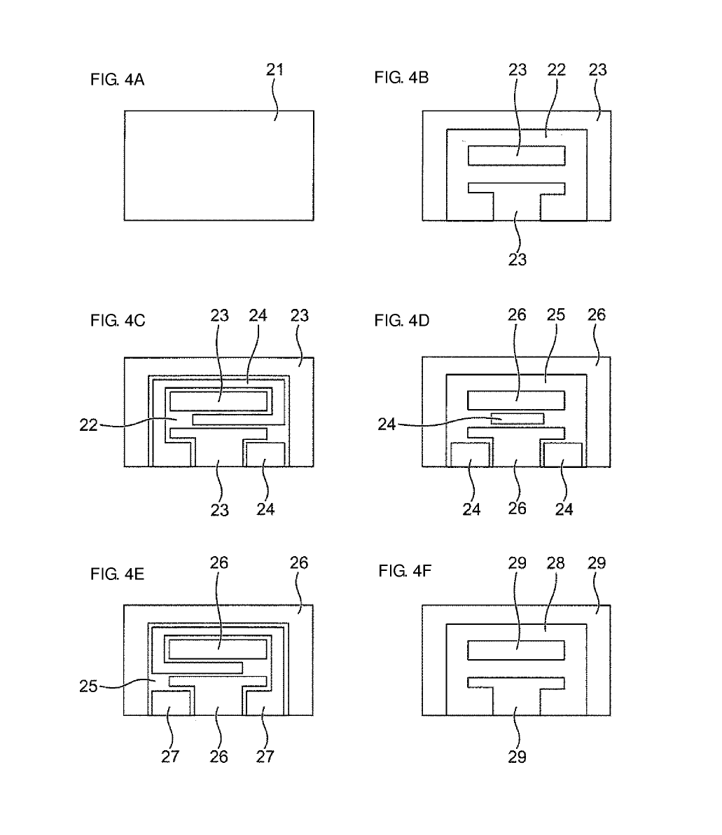

A sintered ceramic substrate 21 is prepared as a substrate (FIG. 4A).

A glass paste layer 22 is formed of the photosensitive glass paste on the substrate 21 by using a photolithography method. Specifically, the glass paste layer 22 is formed by applying the photosensitive glass paste, performing photo-curing through a mask, and performing development (FIG. 4B). Subsequently, a shape-retaining paste layer 23 is formed of the shape-retaining photosensitive paste in the periphery of the glass paste layer 22 by using the photolithography method. Specifically, the shape-retaining paste layer 23 is formed in the periphery of the glass paste layer 22 by applying the shape-retaining photosensitive paste, performing photo-curing through a mask, and performing development (FIG. 4B). As the situation demands, the glass paste layer 22 and the shape-retaining paste layer 23 having predetermined thicknesses may be formed by repeating this procedure.

A conductor paste layer 24 is formed on the glass paste layer 22 by using the photolithography method. Specifically, the conductor paste layer 24 is formed by applying the photosensitive conductor paste, performing photo-curing through a mask, and performing development (FIG. 4C). The conductor paste layer 24 is formed inside the glass paste layer 22 formed in advance.

A glass paste layer 25 is formed on the conductor paste layer 24 by using the photolithography method. Specifically, the glass paste layer 25 is formed so as to cover the conductor paste layer 24 by applying the photosensitive glass paste, performing photo-curing through a mask, and performing development (FIG. 4D). At this time, the glass paste layer 25 is formed in the regions of the conductor paste layer 24 so as to expose the regions serving as the extension portions and the region serving as a connection portion to a conductor paste layer 27 to be formed thereafter. Next, a shape-retaining paste layer 26 is formed of the shape-retaining photosensitive paste in the periphery of the glass paste layer 25 by using the photolithography method. Specifically, the shape-retaining paste layer 26 is formed in the periphery of the glass paste layer 25 by applying the shape-retaining photosensitive paste, performing photo-curing through a mask, and performing development (FIG. 4D). As the situation demands, the glass paste layer 25 and the shape-retaining paste layer 26 having predetermined thicknesses may be formed by repeating this procedure.

A conductor paste layer 27 is formed on the glass paste layer 25 by using the photolithography method. Specifically, the conductor paste layer 27 is formed by applying the photosensitive conductor paste, performing photo-curing through a mask, and performing development (FIG. 4E). The conductor paste layer 27 is formed inside the glass paste layer 25 formed in advance.

A glass paste layer 28 is formed on the conductor paste layer 27 by using the photolithography method. Specifically, the glass paste layer 28 is formed so as to cover the conductor paste layer 27 by applying the photosensitive glass paste, performing photo-curing through a mask, and performing development (FIG. 4F). Next, a shape-retaining paste layer 29 is formed of the shape-retaining photosensitive paste in the periphery of the glass paste layer 28 by using the photolithography method. Specifically, the shape-retaining paste layer 29 is formed in the periphery of the glass paste layer 28 by applying the shape-retaining photosensitive paste, performing photo-curing through a mask, and performing development (FIG. 4F). As the situation demands, the glass paste layer 28 and the shape-retaining paste layer 29 having predetermined thicknesses may be formed by repeating this procedure.

A multilayer body is formed on the substrate as described above.

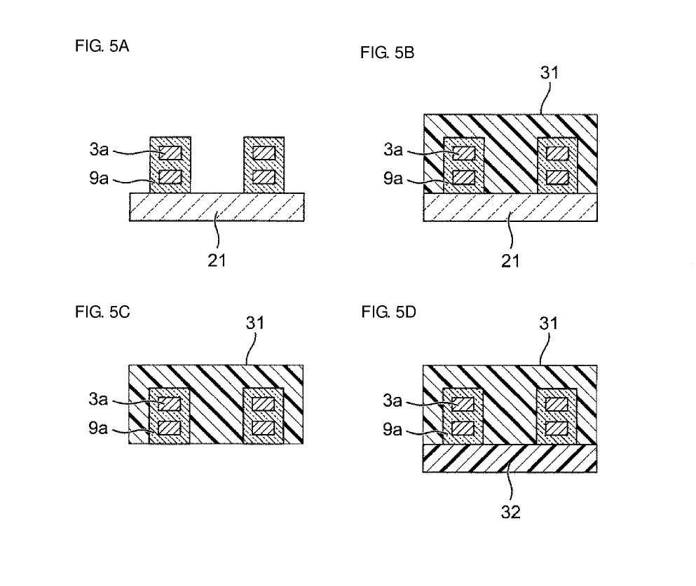

The resulting multilayer body is fired at a temperature of 650° C. to 950° C. The organic material in the shape-retaining paste layer disappears during firing, and the inorganic material that does not sinter, for example, alumina, remains as powder without sintering. The coil portion 3a covered with the glass layer 9a is obtained on the substrate by removing the inorganic material powder (FIG. 5A). The coil portion 3a covered with the glass layer 9a is in close contact with the substrate 21 and, therefore, there are advantages in handling, for example, transportation.

The magnetic sheet is pressed into the coil portion 3a. A magnetic sheet 31 is placed on the coil portion 3 and pressurized by a die or the like so as to make it possible to be pressed into the coil portion 3 (FIG. 5B).

The substrate 21 is removed by grinding or the like (FIG. 5C).

Another magnetic sheet is made to come into close contact with the surface, from which the substrate 21 has been removed, by pressing or the like (FIG. 5D). Thereafter, cutting is performed by a dicer or the like so as to separate the individual element assemblies from each other.

An insulating layer 10a is formed on the entire surface of the resulting element assembly 2a. The insulating layer may be formed by using a known method. For example, a method in which the element surface is covered by spraying an insulating material or a method in which dipping into an insulating material is performed may be used.

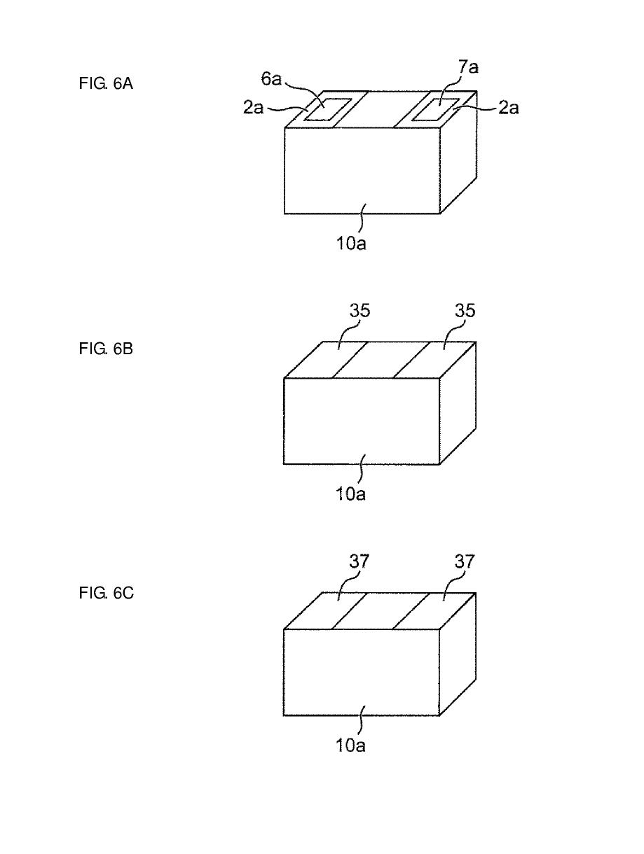

The insulating layer 10a is removed from regions, in which the outer electrodes are to be formed, of the element assembly 2a. Removal may be performed by laser irradiation or a mechanical technique (FIG. 6A).

A Cu layer 35 is formed (FIG. 6B). Forming the Cu layer enables outer electrodes to be smoothly formed on even an element assembly having low electrical conductivity. Subsequently, a Ni layer and a Sn layer are sequentially formed by plating (FIG. 6C).

In this manner, the coil component 1a according to an embodiment of the present disclosure is produced.

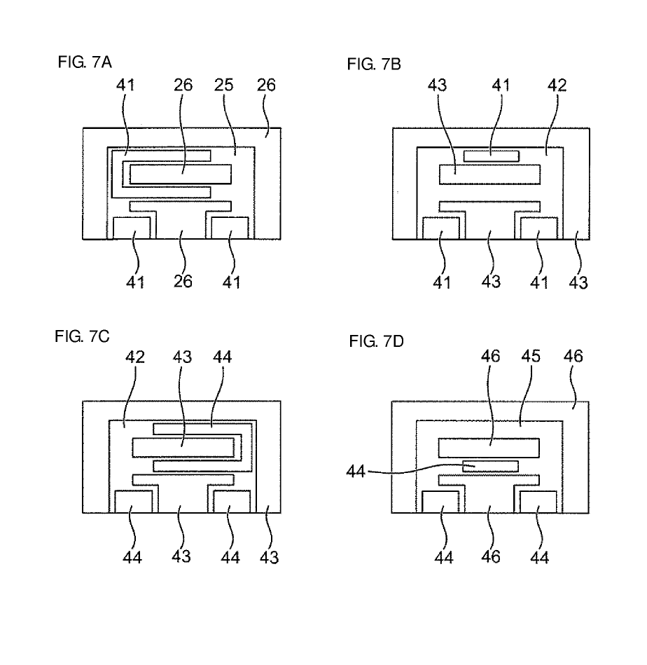

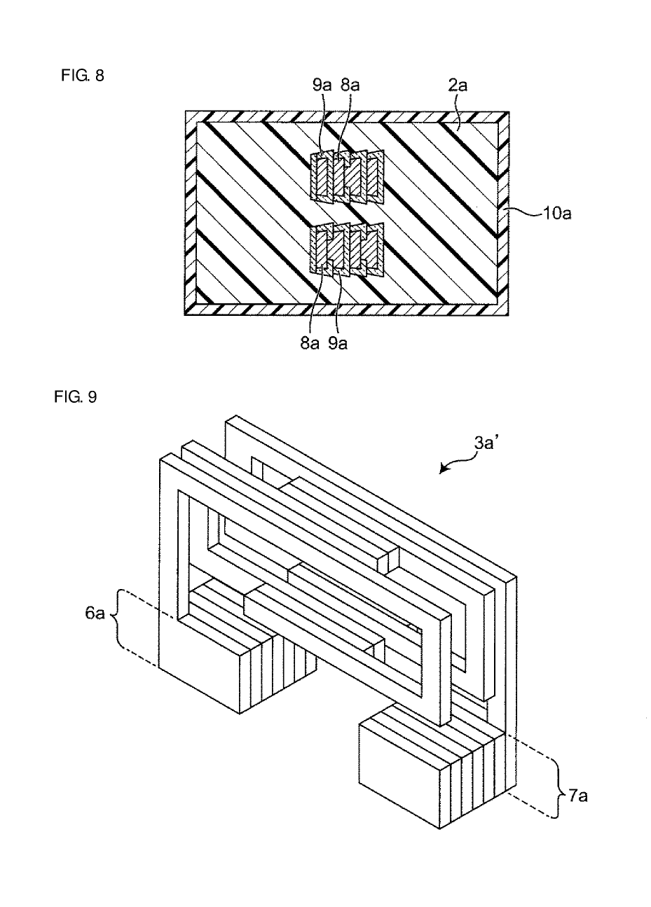

In the coil component 1a, the number of turns of the coil portion 3a is 1.5. However, there is no particular limitation regarding the number of turns of the coil component according to the present disclosure. For example, a coil component having the number of turns of 2.5 may be produced by performing the steps shown in FIGS. 7A to 7D, as described below, between the step shown in FIG. 4D and the step shown in FIG. 4E. FIG. 8 is a sectional view of a coil component having the number of turns of 2.5, and FIG. 9 is a perspective view of a coil portion 3a′ having the number of turns of 2.5.

After the step shown in FIG. 4D, a conductor paste layer 41 is formed on the glass paste layer 25 by using the photolithography method. Specifically, the conductor paste layer 41 is formed by applying the photosensitive conductor paste, performing photo-curing through a mask, and performing development (FIG. 7A). The conductor paste layer 41 is formed inside the glass paste layer 25 formed in advance.

A glass paste layer 42 is formed on the conductor paste layer 41 by using the photolithography method. Specifically, the glass paste layer 42 is formed so as to cover the conductor paste layer 41 by applying the photosensitive glass paste, performing photo-curing through a mask, and performing development (FIG. 7B). At this time, the glass paste layer 42 is formed in the regions of the conductor paste layer 41 so as to expose the regions serving as the extension portions and the region serving as a connection portion to a conductor paste layer 44 to be formed thereafter. Next, a shape-retaining paste layer 43 is formed of the shape-retaining photosensitive paste in the periphery of the glass paste layer 42 by using the photolithography method. Specifically, the shape-retaining paste layer 43 is formed in the periphery of the glass paste layer 42 by applying the shape-retaining photosensitive paste, performing photo-curing through a mask, and performing development (FIG. 7B). As the situation demands, the glass paste layer 42 and the shape-retaining paste layer 43 having predetermined thicknesses may be formed by repeating this procedure.

In the same manner as the steps shown in FIGS. 7A and 7B, the conductor paste layer 44 is formed on the glass paste layer 42 by using the photolithography method (FIG. 7C), a glass paste layer 45 is further formed on the conductor paste layer 44, and a shape-retaining paste layer 46 is formed in the periphery of the glass paste layer 45 (FIG. 7D).

Subsequently, the steps from the step shown in FIG. 4E and thereafter are performed and, thereby, a coil component having the number of turns of 2.5 can be obtained.

Therefore, the present disclosure provides a method for manufacturing a coil component including an element assembly that contains a filler and a resin material, a coil portion composed of a coil conductor that is embedded in the element assembly, and a pair of outer electrodes electrically connected to the coil conductor, wherein the coil conductor is covered with a glass layer, the method including the steps of forming, on a substrate, a conductor paste layer of a photosensitive metal paste containing a metal that constitutes the coil conductor by using a photolithography method, forming a glass paste layer of a photosensitive glass paste containing glass that constitutes the glass layer by using a photolithography method so as to cover the conductor paste layer, forming a retaining layer of a photosensitive paste that can be removed after firing in regions, in which neither the conductor paste layer nor the glass paste layer is present, on the substrate, and forming a coil portion on the substrate by firing the substrate provided with the conductor paste layer, the glass paste layer, and the retaining layer.

In a preferred aspect, the present disclosure provides the manufacturing method further including the steps of removing the substrate and providing the portion, from which the substrate has been removed, with an element assembly sheet.

### Second Embodiment

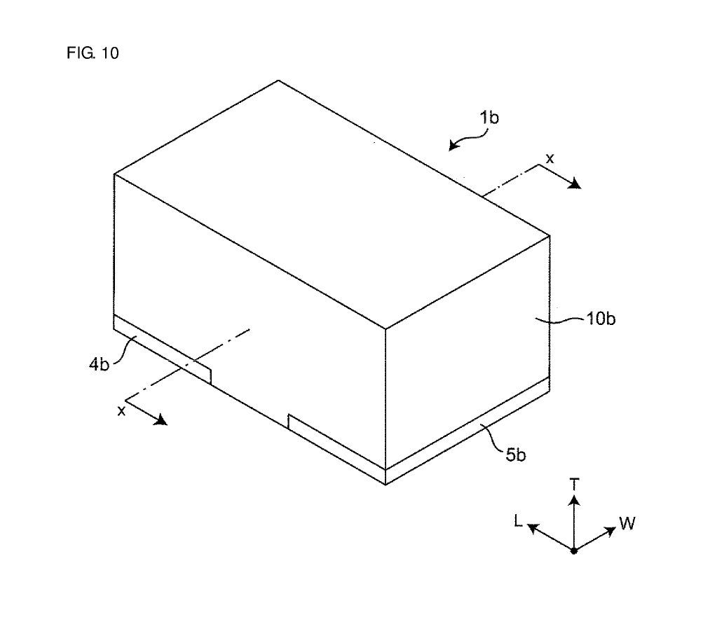

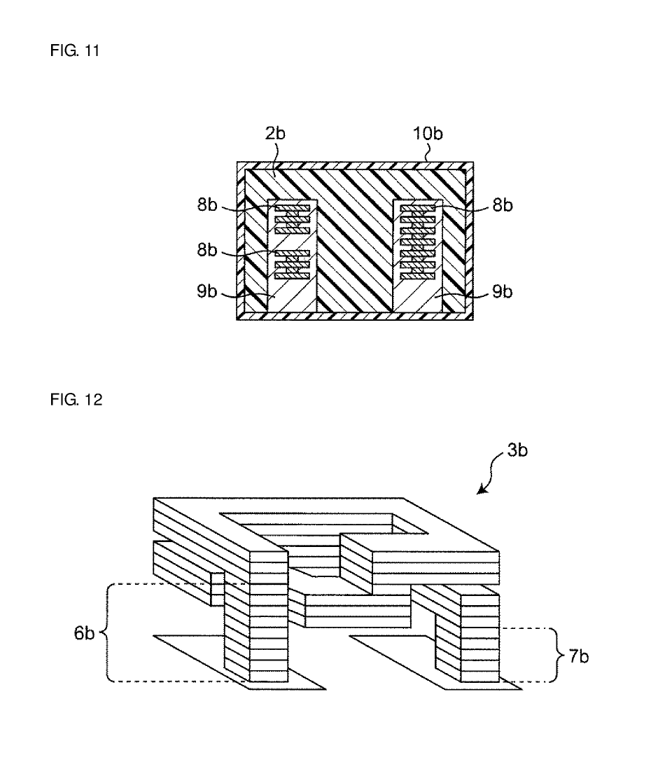

FIG. 10 is a perspective view of a coil component 1b according to the present embodiment, and FIG. 11 is a schematic sectional view. FIG. 12 is a schematic perspective view of a coil portion 3b of the coil component 1b. In this regard, the shapes, arrangements, and the like of the coil component and constituent elements of the embodiment described below are not limited to the examples illustrated.

As shown in FIG. 10 to FIG. 12, the coil component 1b according to the present embodiment is different from the above-described coil component 1a in the axis direction of the coil portion. Specifically, the coil component 1b has the configuration described below. The coil component 1b is in the shape of a substantially rectangular parallelepiped. Briefly, the coil component 1b includes an element assembly 2b, a coil portion 3b embedded in the element assembly 2b, and a pair of outer electrodes 4b and 5b. The coil portion 3b has an axis in upper surface and lower surface directions of the element assembly, that is, an axis perpendicular to a mounting surface. As shown in FIG. 12, the coil portion 3b has extension portions 6b and 7b, and the extension portions 6b and 7b are electrically connected to the outer electrodes 4b and 5b, respectively. As shown in FIG. 11, a coil conductor 8b of the coil portion 3b is covered with a glass layer 9b. Meanwhile, the coil component 1b except the outer electrodes 4b and 5b is covered with an insulating layer 10b.

A method for manufacturing the coil component 1b will be described.

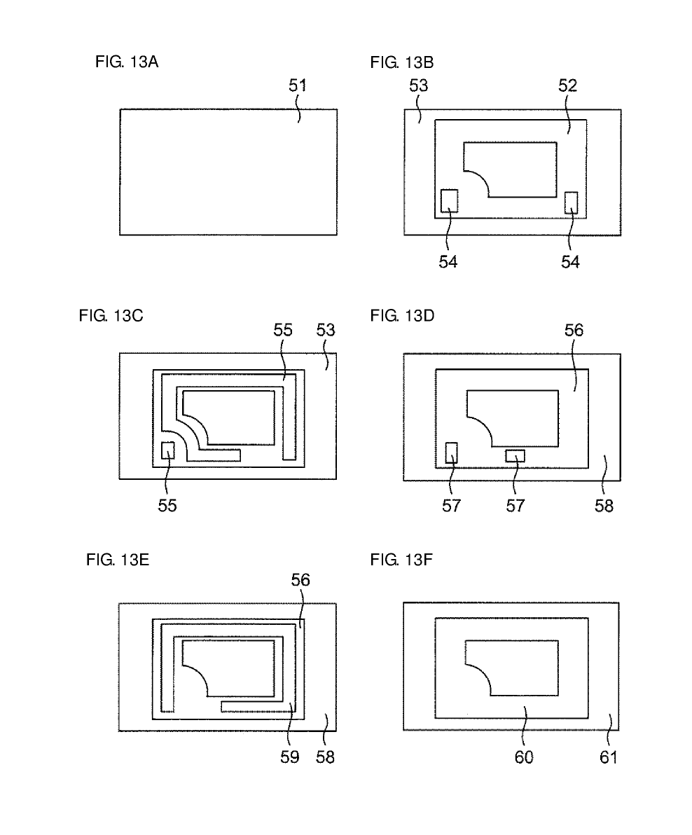

A sintered ceramic substrate 51 is prepared as a substrate (FIG. 13A).

On the substrate 51, a glass paste layer 52 is formed of the photosensitive glass paste by using the photolithography method, and an extension portion conductor paste layer 54 is formed of the photosensitive conductor paste (FIG. 13B). Subsequently, a shape-retaining paste layer 53 is formed of the shape-retaining photosensitive paste in the periphery of the glass paste layer 52 by using the photolithography method (FIG. 13B). As the situation demands, the glass paste layer 52, the shape-retaining paste layer 53, and the conductor paste layer 54 having predetermined thicknesses may be formed by repeating this procedure.

A conductor paste layer 55 is formed on the glass paste layer 52 by using the photolithography method (FIG. 13C). In addition, the conductor paste layer 55 is formed on the extension portion conductor paste layer 54.

A glass paste layer 56 is formed on the conductor paste layer 55 by using the photolithography method (FIG. 13D). At this time, a conductor paste layer 57 is formed in the region serving as a connection portion of the coil conductor (FIG. 13D). Next, a shape-retaining paste layer 58 is formed of the shape-retaining photosensitive paste in the periphery of the glass paste layer 56 by using the photolithography method (FIG. 13D). As the situation demands, the glass paste layer 56, the conductor paste layer 57, and the shape-retaining paste layer 58 having predetermined thicknesses may be formed by repeating this procedure.

A conductor paste layer 59 is formed on the glass paste layer 56 by using the photolithography method (FIG. 13E).

A glass paste layer 60 is formed on the conductor paste layer 59 by using the photolithography method (FIG. 13F). Next, a shape-retaining paste layer 61 is formed of the shape-retaining photosensitive paste in the periphery of the glass paste layer 60 by using the photolithography method (FIG. 13F). As the situation demands, the glass paste layer 60 and the shape-retaining paste layer 61 having predetermined thicknesses may be formed by repeating this procedure.

A multilayer body is formed on the substrate as described above.

Thereafter, in the same manner as the coil component 1a, the multilayer is fired, an element assembly portion is formed using a magnetic sheet, and outer electrodes are formed by plating so as to produce the coil component 1b.

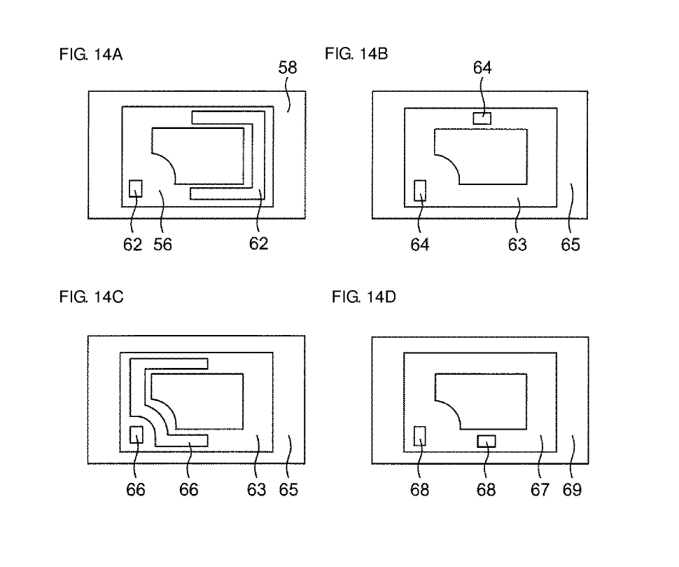

In the coil component 1b, the number of turns of the coil portion 3b is 1.5. However, there is no particular limitation regarding the number of turns of the coil component according to the present disclosure. For example, a coil component having the number of turns of 2.5 may be produced by performing the steps shown in FIGS. 14A to 14D, as described below, between the step shown in FIG. 13D and the step shown in FIG. 13E.

After the step shown in FIG. 13D, a conductor paste layer 62 is formed on the glass paste layer 56 by using the photolithography method (FIG. 14A).

A glass paste layer 63 is formed on the conductor paste layer 62 by using the photolithography method (FIG. 14B). At this time, the conductor paste layer 64 is formed in the region serving as the extension portion and the region serving as a connection portion to a conductor paste layer 66 to be formed thereafter of the conductor paste layer 62 (FIG. 14B). Next, a shape-retaining paste layer 65 is formed of the shape-retaining photosensitive paste in the periphery of the glass paste layer 63 by using the photolithography method (FIG. 14B). As the situation demands, the glass paste layer 63, the conductor paste layer 64, and the shape-retaining paste layer 65 having predetermined thicknesses may be formed by repeating this procedure.

In the same manner as the steps shown in FIGS. 14A and 14B, the conductor paste layer 66 is formed on the glass paste layer 63 by using the photolithography method (FIG. 14C), a glass paste layer 67 and a conductor paste layer 68 are further formed on the conductor paste layer 66, and a shape-retaining paste layer 69 is formed in the periphery of the glass paste layer 67 (FIG. 14D).

Subsequently, the steps from the step shown in FIG. 13E and thereafter are performed and, thereby, a coil component having the number of turns of 2.5 can be obtained.

### Third Embodiment

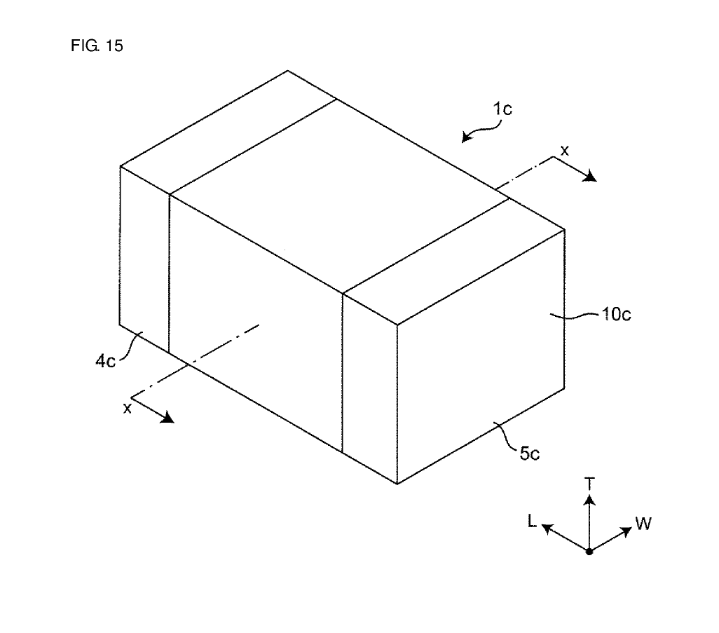

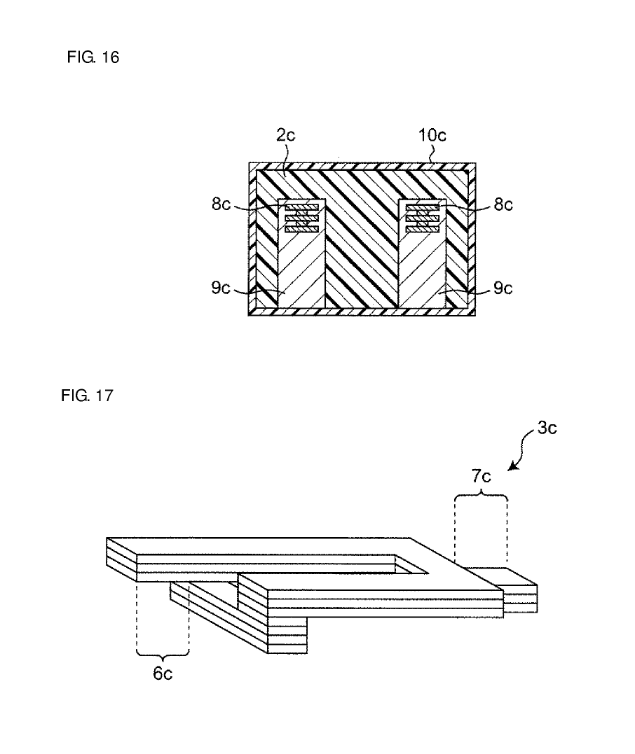

FIG. 15 is a perspective view of a coil component 1c according to the present embodiment, and FIG. 16 is a schematic sectional view. FIG. 17 is a schematic perspective view of a coil portion 3c of the coil component 1c. In this regard, the shapes, arrangements, and the like of the coil component and constituent elements of the embodiment described below are not limited to the examples illustrated.

As shown in FIG. 15 to FIG. 17, the coil component 1c according to the present embodiment is different from the above-described coil component 1a in the axis direction of the coil portion and the exposure direction of the extension portions. Specifically, the coil component 1c has the configuration described below. The coil component 1c is in the shape of a substantially rectangular parallelepiped. Briefly, the coil component 1c includes an element assembly 2c, a coil portion 3c embedded in the element assembly 2c, and a pair of outer electrodes 4c and 5c. The outer electrodes 4c and 5c are so-called five-surface electrodes. The coil portion 3c has an axis in upper surface and lower surface directions of the element assembly, that is, an axis perpendicular to a mounting surface. As shown in FIG. 17, the coil portion 3c has extension portions 6c and 7c, and the extension portions 6c and 7c are electrically connected to the outer electrodes 4c and 5c, respectively, on right and left end surfaces. As shown in FIG. 16, a coil conductor 8c of the coil portion 3c is covered with a glass layer 9c. Meanwhile, the coil component 1c except the outer electrodes 4c and 5c is covered with an insulating layer 10c.

A method for manufacturing the coil component 1c will be described.

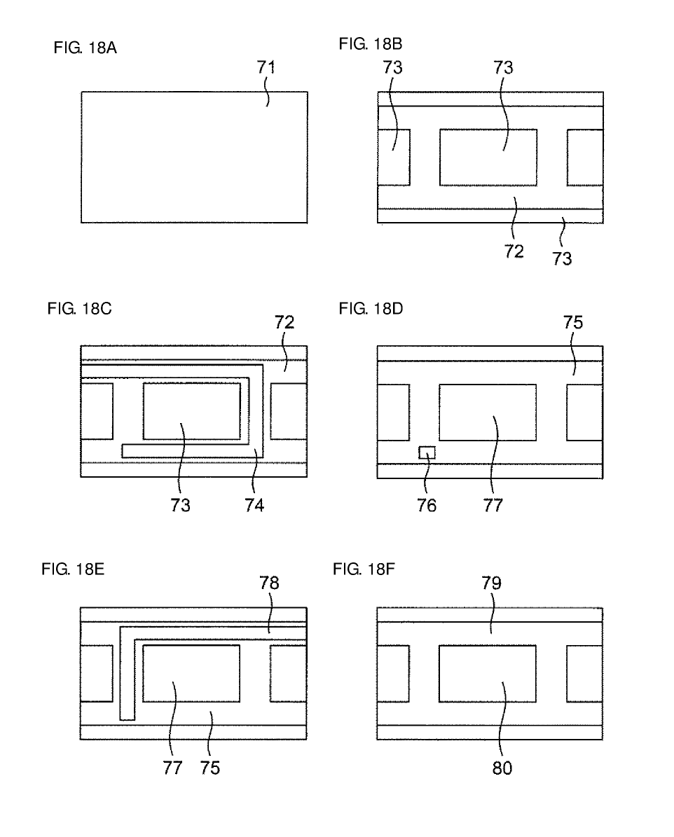

A sintered ceramic substrate 71 is prepared as a substrate (FIG. 18A).

On the substrate 71, a glass paste layer 72 is formed of the photosensitive glass paste by using the photolithography method (FIG. 18B). Subsequently, a shape-retainingpaste layer 73 is formed of the shape-retaining photosensitive paste in the periphery of the glass paste layer 72 by using the photolithography method (FIG. 18B). As the situation demands, the glass paste layer 72 and the shape-retaining paste layer 73 having predetermined thicknesses may be formed by repeating this procedure.

A conductor paste layer 74 is formed on the glass paste layer 72 by using the photolithography method (FIG. 18C).

A glass paste layer 75 is formed on the conductor paste layer 74 by using the photolithography method (FIG. 18D). At this time, a conductor paste layer 76 is formed in the region serving as a connection portion of the coil conductor (FIG. 18D). Next, a shape-retaining paste layer 77 is formed of the shape-retaining photosensitive paste in the periphery of the glass paste layer 75 by using the photolithography method (FIG. 18D). As the situation demands, the glass paste layer 75, the conductor paste layer 76, and the shape-retaining paste layer 77 having predetermined thicknesses may be formed by repeating this procedure.

A conductor paste layer 78 is formed on the glass paste layer 75 by using the photolithography method (FIG. 18E).

A glass paste layer 79 is formed on the conductor paste layer 78 by using the photolithography method (FIG. 18F). Next, a shape-retaining paste layer 80 is formed of the shape-retaining photosensitive paste in the periphery of the glass paste layer 79 by using the photolithography method (FIG. 18F). As the situation demands, the glass paste layer 79 and the shape-retaining paste layer 80 having predetermined thicknesses may be formed by repeating this procedure.

A multilayer body is formed on the substrate as described above.

Thereafter, in the same manner as the coil component 1a, the multilayer is fired, an element assembly portion is formed using a magnetic sheet, and outer electrodes are formed by plating so as to produce the coil component 1c.

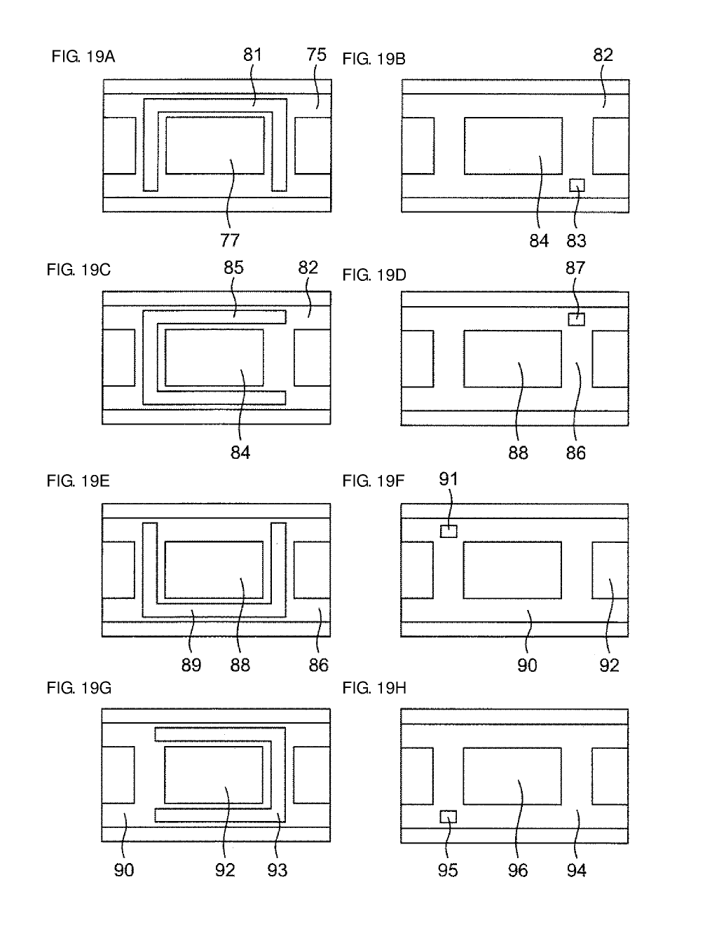

In the coil component 1c, the number of turns of the coil portion 3c is 1.5. However, there is no particular limitation regarding the number of turns of the coil component according to the present disclosure. For example, a coil component having the number of turns of 3.5 may be produced by performing the steps shown in FIGS. 19A to 19H, as described below, between the step shown in FIG. 18D and the step shown in FIG. 18E.

After the step shown in FIG. 18D, a conductor paste layer 81 is formed on the glass paste layer 75 by using the photolithography method (FIG. 19A).

A glass paste layer 82 is formed on the conductor paste layer 81 by using the photolithography method (FIG. 19B). At this time, a conductor paste layer 83 is formed in the region serving as a connection portion to a conductor paste layer 85 to be formed thereafter of the conductor paste layer 81 (FIG. 19B). Next, a shape-retaining paste layer 84 is formed of the shape-retaining photosensitive paste in the periphery of the glass paste layer 82 by using the photolithography method (FIG. 19B). As the situation demands, the glass paste layer 82, the conductor paste layer 83, and the shape-retaining paste layer 84 having predetermined thicknesses may be formed by repeating this procedure.

In the same manner as the steps shown in FIGS. 19A and 19B, the conductor paste layer 85 is formed on the glass paste layer 82 by using the photolithography method (FIG. 19C), a glass paste layer 86 and a conductor paste layer 87 are further formed on the conductor paste layer 85, and a shape-retaining paste layer 88 is formed in the periphery of the glass paste layer 86 (FIG. 19D). In addition, a conductor paste layer 89 is formed on the glass paste layer 86 by using the photolithography method (FIG. 19E), a glass paste layer 90 and a conductor paste layer 91 are formed on the conductor paste layer 89, and a shape-retaining paste layer 92 is formed in the periphery of the glass paste layer 90 (FIG. 19F). Further, a conductor paste layer 93 is formed on the glass paste layer 90 by using the photolithography method (FIG. 19G), a glass paste layer 94 and a conductor paste layer 95 are formed on the conductor paste layer 93, and a shape-retaining paste layer 96 is formed in the periphery of the glass paste layer 94 (FIG. 19H).

Subsequently, the steps from the step shown in FIG. 18E and thereafter are performed and, thereby, a coil component having the number of turns of 3.5 can be obtained.

The coil component and the method for manufacturing the same according to the present disclosure are as described above. However, the present disclosure is not limited to the above-described embodiments, and the design can be changed within the scope of the gist of the present disclosure.

In each of the first to third embodiments, the element assembly is formed by using a magnetic sheet that is a composite material containing the filler and the resin material, and the element assembly is not subjected to the firing step. However, the coil component according to the present disclosure is not limited to this.

According to an aspect, the filler may be formed by firing and, thereafter, gap portions may be filled with the resin so as to form the element assembly 2a.

According to another aspect, the element assembly may be formed by casting a slurry that includes a composite material containing the filler and the resin material and performing heat-curing.

In each of the first to third embodiments, the coil portion covered with the glass layer is obtained by firing, the element assembly is obtained by pressing the magnetic sheet into the coil portion, and the Cu plating, the Ni plating, and the Sn plating are applied to the element assembly so as to form the outer electrodes. However, the coil component according to the present disclosure is not limited to this.

According to an aspect, the magnetic sheet may be pressed into the coil portion, the element assembly may be obtained by heat-curing, and the outer electrodes may be formed by applying the Cu plating, the Ni plating, the Sn plating, and the like to the element assembly.

According to another aspect, the magnetic sheet may be pressed into the coil portion, the element assembly may be obtained by heat-curing, underlying electrodes may be formed by baking Ag, and the outer electrodes may be formed by applying the Ni plating, the Sn plating, and the like thereto.

According to another aspect, the magnetic sheet may be pressed into the coil portion, a sintered body is obtained by firing, underlying electrodes may be formed by baking Ag on the sintered body, voids of the sintered body may be impregnated with the resin, and finally a Ni plating, a Sn plating, and the like may be applied so as to form the outer electrodes.

According to another aspect, after the coil portion is obtained, the element assembly may be obtained by casting a slurry that includes a composite material containing the filler and the resin material and heat-curing the resulting slurry, and the outer electrodes may be formed on the element assembly.

### EXAMPLES

Production of Magnetic Sheet

An Fe—Si-based alloy powder having the D50 (particle diameter at cumulative percentage of 50% on a volume basis) of 5 μm was prepared. Regarding the alloy powder, about 50 nm of SiO₂ coating was formed on the powder surface in advance by a sol-gel method using tetraethyl orthosilicate (TEOS) as a metal alkoxide. A magnetic sheet was obtained by wet-mixing predetermined amounts of alloy powder and epoxy resin and forming the resulting mixture into a sheet (thickness of 100 μm) by a doctor blade method.

Production of Photosensitive Glass Paste

A borosilicate glass (SiO₂—B₂O₃—K₂O)-based glass powder having the D50 of 1 μm was prepared and mixed with a copolymer of methyl methacrylate and methacrylic acid (acrylic polymer), dipentaerythritol pentaacrylate (photosensitive monomer), dipropylene glycol monomethyl ether (solvent), 2,4-diethylthioxanthone, 2-methyl-1-[4-(methylthio)phenyl]-2-morpholinopropan-1-one, bis(2,4,6-trimethylbenzoyl)phenylphosphine oxide (photopolymerization initiator), and a dispersing agent so as to produce a photosensitive glass paste.

Photosensitive Conductor Paste

A Ag powder having the D50 of 2 μm was prepared and mixed with a copolymer of methyl methacrylate and methacrylic acid (acrylic polymer), dipentaerythritol pentaacrylate (photosensitive monomer), dipropylene glycol monomethyl ether (solvent), 2,4-diethylthioxanthone, 2-methyl-1-[4-(methylthio)phenyl]-2-morpholinopropan-1-one, bis (2,4,6-trimethylbenzoyl)phenylphosphine oxide (photopolymerization initiator), and a dispersing agent so as to produce a photosensitive conductor paste.

Shape-Retaining Photosensitive Paste

An alumina powder having the D50 of 10 μm was prepared and mixed with a copolymer of methyl methacrylate and methacrylic acid (acrylic polymer), dipentaerythritol pentaacrylate (photosensitive monomer), dipropylene glycol monomethyl ether (solvent), 2,4-diethylthioxanthone, 2-methyl-1-[4-(methylthio)phenyl]-2-morpholinopropan-1-one, bis (2,4,6-trimethylbenzoyl)phenylphosphine oxide (photopolymerization initiator), and a dispersing agent so as to produce a photosensitive alumina paste.

Production of Coil Component

A substrate (ceramic sintered substrate having a thickness of 0.5 mm or more) was prepared (FIG. 4A). The photosensitive glass paste was applied to the substrate by screen printing and dried. Thereafter, ultraviolet rays were applied through a mask so as to perform photo-curing. An uncured portion was removed by a tetramethyl ammonium hydroxide (TMAH) aqueous solution serving as a developing solution so as to form a glass paste layer having a predetermined form. Subsequently, a photosensitive alumina paste was applied by printing, exposed, and developed in the same manner so as to form an alumina layer in the periphery of the glass layer (FIG. 4B).

The photosensitive conductor paste was applied by printing, exposed, and developed in the above-described manner so as to form a conductor paste layer having a predetermined form (coil pattern 1) on the glass paste layer. The photosensitive glass paste was applied by coating, photo-cured through a mask, and developed so as to form a glass paste layer around the conductor layer (FIG. 4C). The photosensitive alumina paste was applied by coating and photo-cured through a mask so as to form an alumina layer in the periphery of the glass paste layer (FIG. 4C). This step was repeated five times so as to form the coil pattern 1.

The photosensitive glass paste was applied by coating, photo-cured through a mask, and developed so as to form a glass paste layer in a region except a connection portion conductor layer (FIG. 4D). The photosensitive alumina paste was applied by coating and photo-cured through a mask so as to form an alumina layer in the periphery of the glass paste layer (FIG. 4D).

The photosensitive conductor paste was applied by printing in the above-described manner, and exposed and developed in the above-described manner so as to form a conductor paste layer having a predetermined form (coil pattern 2) on the glass paste layer (FIG. 4E). This step was repeated five times so as to form the coil pattern 2.

The photosensitive glass paste was applied by coating, photo-cured through a mask, and developed in the above-described manner so as to form a glass paste layer in a region except a connection portion conductor layer (FIG. 4F).

A multilayer body composed of the conductor paste layers and the glass layers supported by the shape-retaining paste layers was obtained on the substrate by the above-described steps.

The multilayer body obtained as described above was fired at 700° C. The metal of the conductor paste layer and the glass of the glass paste layer sintered during the firing so as to become the coil conductor and the glass layer, respectively. Meanwhile, alumina of the shape-retaining paste layer did not sinter and remained as an unsintered alumina powder. The alumina powder was removed, and so a coil component supported by the substrate and the surface of which was covered with a glass layer was obtained (FIG. 5A).

Next, a magnetic sheet was placed on the side of the substrate provided with the coil portion, a die was used for holding, and the magnetic sheet was pressed into the coil portion by being pressurized by a press (FIG. 5B).

The substrate was removed by grinding (FIG. 5C).

Another magnetic sheet was placed on the surface, from which the substrate had been removed, a die was used for holding, and the magnetic sheet was made to come into close contact with the surface by being pressurized by a press (FIG. 5D).

Thereafter, cutting was performed by a dicer so as to separate the individual elements from each other.

An insulating layer was formed on the element surface by spraying an epoxy resin while shaking the resulting element and, thereafter, performing heat-curing.

The insulating layer was removed from regions, in which the outer electrodes were to be formed, of the element assembly by laser irradiation (FIG. 6A). Thereafter, outer electrodes were formed by sequentially depositing a Cu coating, a Ni coating, and a Sn coating on and above an exposed coil by electroplating.

In this manner, the coil component was obtained. The resulting coil component had a length (L) of 1.0 mm, a width (W) of 0.5 mm, and a height (T) of 0.5 mm The thickness of the coil conductor was 100 μm, the width of the coil conductor was 120 μm, the width of the extension portion was 300 μm, and the thickness of the glass layer was 15 μm.

The coil component according to the present disclosure may be widely used for various applications, for example, an inductor.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. A coil component comprising:
an element assembly that contains a filler and a resin material;
a coil portion composed of a coil conductor that is embedded in the element assembly; and
a pair of outer electrodes electrically connected to the coil conductor, the coil conductor being covered with a glass layer.

2. The coil component according to claim 1, wherein the thickness of the glass layer is from 3 μm to 30 μm.

3. The coil component according to claim 1, wherein the thickness of the coil conductor is from 3 μm to 200 μm.

4. The coil component according to claim 1, wherein the outer electrodes are disposed on the lower surface of the element assembly.

5. The coil component according to claim 1, wherein the filler is metal particles, ferrite particles, or glass particles.

6. The coil component according to claim 5, wherein the filler is metal particles.

7. The coil component according to claim 1, wherein the axis direction of the coil portion is parallel to the lower surface of the element assembly.

8. The coil component according to claim 1, wherein the coil conductor is fired and the element assembly is unfired.

9. The coil component according to claim 2, wherein the thickness of the coil conductor is from 3 μm to 200 μm.

10. The coil component according to claim 2, wherein the outer electrodes are disposed on the lower surface of the element assembly.

11. The coil component according to claim 3, wherein the outer electrodes are disposed on the lower surface of the element assembly.

12. The coil component according to claim 2, wherein the filler is metal particles, ferrite particles, or glass particles.

13. The coil component according to claim 3, wherein the filler is metal particles, ferrite particles, or glass particles.

14. The coil component according to claim 4, wherein the filler is metal particles, ferrite particles, or glass particles.

15. The coil component according to claim 2, wherein the axis direction of the coil portion is parallel to the lower surface of the element assembly.

16. The coil component according to claim 3, wherein the axis direction of the coil portion is parallel to the lower surface of the element assembly.

17. The coil component according to claim 2, wherein the coil conductor is fired and the element assembly is unfired.

18. The coil component according to claim 3, wherein the coil conductor is fired and the element assembly is unfired.

19. A method for manufacturing a coil component including
an element assembly that contains a filler and a resin material,
a coil portion composed of a coil conductor that is embedded in the element assembly, and
a pair of outer electrodes electrically connected to the coil conductor, the coil conductor being covered with a glass layer,
the method comprising:
forming, on a substrate, a conductor paste layer of a photosensitive metal paste containing a metal that constitutes the coil conductor by using a photolithography method;
forming a glass paste layer of a photosensitive glass paste containing glass that constitutes the glass layer by using the photolithography method so as to cover the conductor paste layer;
forming a retaining layer of a photosensitive paste that can be removed after firing in regions, in which neither the conductor paste layer nor the glass paste layer is present, on the substrate; and
forming a coil portion on the substrate by firing the substrate provided with the conductor paste layer, the glass paste layer, and the retaining layer.

20. The method for manufacturing a coil component according to claim 19, further comprising:
pressing an element assembly sheet containing an element assembly material into the coil portion disposed on the substrate;
removing the substrate; and
providing the portion, from which the substrate has been removed, with an element assembly sheet.
